(19) United States
(12) Patent Application Publication
(10) Pub. No.: US 2015/0348071 A1
(43) Pub. Date: Dec. 3, 2015

(54) SERVER AND METHOD FOR GENERATING PREDICTIVE PATTERNS FOR WEBSITE ANALYSIS

(71) Applicant: IPERCEPTIONS INC, Montreal (CA)

(72) Inventors: Lane COCHRANE, Kirkland (CA); Audry LAROCQUE, Ville Mont-Royal (CA); Matthew BUTLER, Montreal (CA)

(73) Assignee: IPERCEPTIONS INC, Montreal (CA)

(21) Appl. No.: 14/288,347

(22) Filed: May 27, 2014

(51) Int. Cl. G06Q 30/02; G06F 17/30

(52) U.S. Cl. CPC G06Q 30/0204; G06Q 30/0203; G06F 17/30864

(57) ABSTRACT

The present disclosure relates to a method and survey server for generating predictive patterns for website analysis. Behavioral data are collected at the survey server from a plurality of user devices. The behavioral data are representative of actions performed by a user of each of the plurality of user devices while visiting a website. Server survey participation data are also collected at the survey server from some of the plurality of user devices. The survey participation data correspond to survey information received from the users of each of the plurality of the user devices when visiting the website. The survey participation data and related behavioral data are analyzed by the survey server to generate predictive survey participation patterns. Contextual data may also collected from some of the plurality of user devices and analyzed with related collected contextual data for generating predictive contextual patterns.

### FIELD OF THE DISCLOSURE

The present disclosure relates to the field of website analytics, and more precisely to the field of collection of data from website visitors, and analysis of the collected data to predict patterns.

### BACKGROUND

It is very important for corporations to understand their patrons, and even more to identify the potential intent of their patrons in relation with their brand, services and products. Inaccurate identification of patron's intents may result in great losses, for instance loss of sales, inaccurate responses to the needs of the patrons, loss of fidelity of the patrons to the brand, etc. Accordingly, any tool to increase the corporate understanding of their patrons, and the validity level associable to this knowledge, has important value for corporations.

The same applies to tools used to interact with these patrons. The more efficient they are, the more efficient the processes to monetize the interactions with these patrons. Accordingly, evaluation tools are necessary to establish the efficiency of the tools used to interact with the patrons, including tools used to evaluate websites.

Currently, the most commonly used tools to acquire this kind of information (i.e. understanding the level of success of a website) consist in the following types of tools: (1) web analytics tools such as Google Analytics and (2) survey tools. Another type of available tools consists in: (3) session recording tools, also known as session replay processes. While the first type provides tools to follow actions performed by visitors of a website (therefore respond to the WHAT question), it fails to provide tools to understand the reasons for a visitor not completing a task (the WHY question), such as not being able to complete a purchase. The second type, while being a good tool to understand the reasons for a visitor for not having completed the task, lacks to provide perspective on the bases for the opinions provided by the visitor, thus lacking to provide any hint of a solution to correct the situation. The third type, as good as it is to understand the actions of a visitor, remains, as the first tool, based on actions performed by visitors of the website.

Accordingly, based on the broad impact of these tools on businesses and technical solutions used by these businesses, improvements in these technical solutions are widely sought. More precisely, there is an important need for a server and method for generating predictive patterns for website analysis.

### SUMMARY

According to a first aspect, the present disclosure relates to a method of generating predictive patterns for website analysis. The method comprises collecting, at a survey server, behavioral data from a plurality of user devices. The behavioral data are representative of a series of actions performed by a user of each of the plurality of user devices while visiting a website. The method also comprises collecting, at the survey server, survey participation data from some of the plurality of user devices. The survey participation data correspond to survey information received from the users of some of the plurality of the user devices in relation to the visiting of the website. The method further comprises analyzing, by the survey server, the survey participation data and related behavioral data to identify predictive survey participation patterns.

According to a second aspect, the present disclosure relates to a survey server. The server comprises a processing system, communications interface for exchanging data with user devices, and memory. The memory stores survey participation data and related behavioral data for some of the user devices. The memory also stores behavioral data for the other user devices. The memory further stores code. The code is responsible, when performed by the processing system, for analyzing the survey participation data and related behavioral data for identifying predictive survey participation patterns. The code is also responsible, when performed by the processing system, for generating adjusted metrics based on the stored survey participation data, and on the predictive survey participation patterns applied to the stored behavioral data for the other user devices.

According to a third aspect, the present disclosure relates to a method of generating predictive contextual patterns. The method comprises collecting, at a survey server, behavioral data from a plurality of user devices. The behavioral data are representative of a series of actions performed by a user of each of the plurality of user devices while visiting a website. The method also comprises collecting, at the survey server, contextual data from some of the plurality of user devices. The contextual data correspond to at least one of the following: hardware configuration, software configuration, user device configuration and user preferences. The method further comprises analyzing, by the survey server, the collected behavioral data and the related collected contextual data for generating predictive contextual patterns. The predictive contextual patterns identify predicted contextual data based on the collected behavioral data for the user devices for which behavioral data has been collected and no related contextual data has been collected.

According to a fourth aspect, the present disclosure relates to a server. The server comprises a processing system, communications interface for exchanging data with user devices and memory. The memory stores contextual data and related behavioral data for some of the user devices, and behavioral data with no related contextual data for the other user devices. The memory further stores code. The code is responsible, when performed by the processing system, for analyzing the contextual data and related behavioral data for identifying predictive contextual patterns. The code is also responsible, when performed by the processing system, for generating predicted contextual data for the other user devices by applying the predictive contextual patterns to the stored behavioral data.

### BRIEF DESCRIPTION OF THE DRAWINGS

Embodiments of the disclosure will be described by way of example only with reference to the accompanying drawings, in which:

FIG. 1 is an exemplary schematic illustration of a survey server in communication over the Internet;

FIG. 2a is an exemplary schematic illustration of a user device of FIG. 1 hosting a web client;

FIG. 2b is an exemplary schematic functional illustration of the web client of FIG. 2a;

FIG. 3 is an exemplary schematic illustration of interactions between a user device, a web server and a survey server;

FIG. 4 is an exemplary flow chart illustrating steps performed by the survey server, the user device and the web server;

FIGS. 5a to 5f are schematic illustrations of a flow of user interfaces on the user device;

FIGS. 6a and 6b are exemplary flow charts illustrating steps performed by the user device;

FIG. 7a is a table schematically illustrating an exemplary life cycle of Internet cookie(s) functionalities;

FIG. 7b is an exemplary schematic illustration of the Internet cookie functionalities;

FIG. 8 is an exemplary flow chart illustrating steps performed by the survey server;

FIG. 9 is simplified flow chart illustrating other steps performed by the survey server;

FIG. 10 is a simplified exemplary schematic illustration of the survey server; and

FIG. 11a and FIG. 11b are simplified exemplary graphical representations of adjusted metrics.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

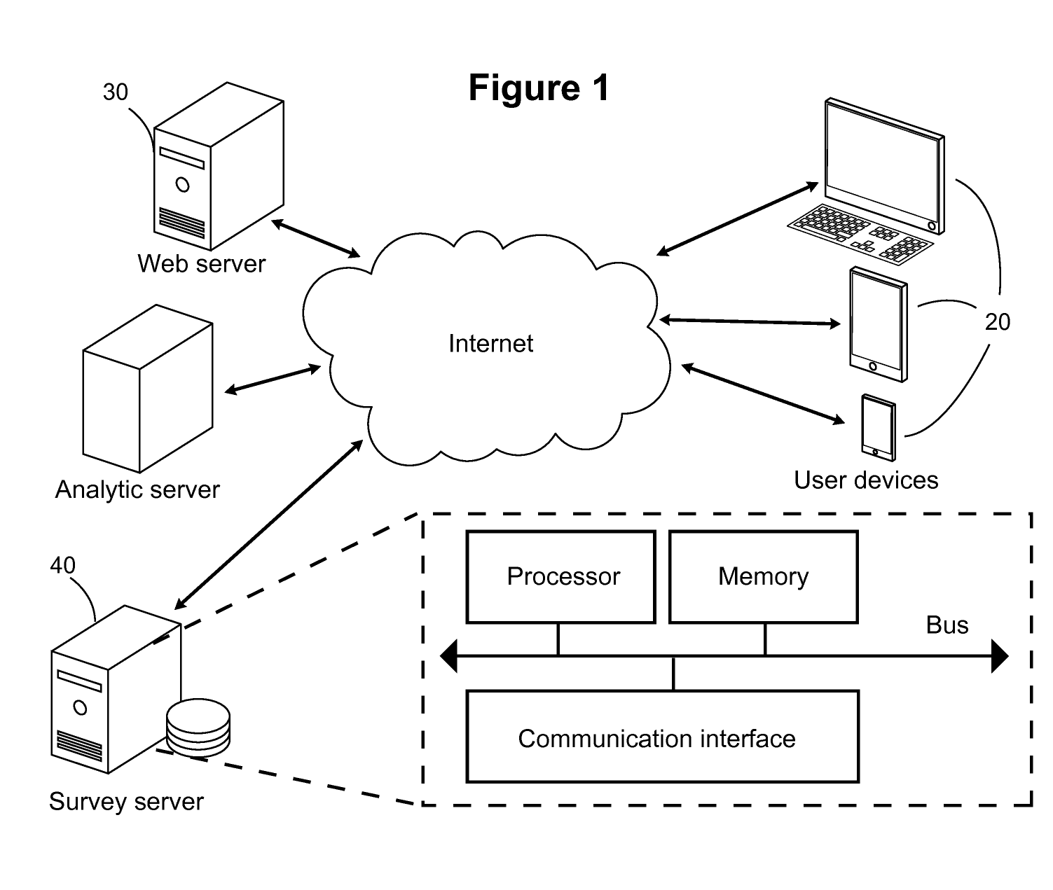

Reference is made to FIG. 1, which represents a transaction-based environment (such as for example an electronic commerce environment) involving user devices 20 each hosting a web client (for instance a web browser), a web server 30 and a survey server 40. The user devices 20, the web server 30 and the survey server 40 are in communication over a communication network, such as the Internet or a plurality of networks linked or bridged electronically, optically or wirelessly and permitting communication between there between.

The present disclosure provides a method and server for generating predictive patterns for website analysis, and a method and server for generating predictive contextual patterns, will be depicted in relation with the above-described environment. This environment is for illustration purposes only. It is not intended to limit the scope of the present methods and servers. Furthermore, optional devices (not illustrated in the Figures) may also participate in the above-described environment either in the form of additional components, or as co-located functionalities to the presented servers. Examples of optional devices include a web analytic server and a tag management server.

To clarify the current description, the following definitions are provided:

Web Protocol: a web protocol is used for communication between any type of devices interconnected over the Internet or any other network(s. Examples of applicable web protocols include HTTP, HTTPS, web services, AJAX, WebDAV, etc. Because most web communications occur over the HTTP protocol, the present disclosure uses the term HTTP as a synonym for web protocol, but any other web protocol could be used in the context of the present disclosure.

Web client: a software implemented on a device that is adapted to provide the appropriate runtime environment for the processing system of the device to process content (webpage content) received over the Internet via one or more web protocols. Examples of web client include: a web browser, an email client, an RSS reader, hosted on a desktop computer, a laptop computer, a mobile or another digital device.

Web Server: a device receiving and responding to requests over the Internet by Internet-communicating devices using web protocols. A web server can include multiple virtual or physical machines providing responses to web protocol requests, such as webpage content to generate webpages of a website on a web client, RSS data, etc. Often such web servers are behind a device that balances the workload between the different physical servers.

Website: a common structure combining a collection of webpages, web application components, and other resources residing on a web server. Each website typically corresponds to a single domain or subdomain.

Webpage: result (processed outcome) of a complete HTTP request and response, including any additional HTTP requests and responses required to load images, CSS files, additional webpage content and other resources. Includes both data and communications required to represent and transmit the layout and content forming the webpage, and therefore is directly responsible of the user's experience of that collection of resources as a single logical component in a web client. Web clients other than Web browsers, such as RSS readers and mobile devices, can access webpages and other webpage content. The main content of the webpage is frequently identified as a HTML document.

Webpage content: data part of a webpage, such as an image, a search box, a login form, a shopping cart, a multimedia resource, or another type of component. A webpage typically consists of a plurality and/or hierarchy of numerous webpage contents, such as an HTML table containing a login form containing a username text input component, which may exist within a webpage that also contains a search box, any number of links, and any number of additional contents. Exemplary types of webpage content include HTML pages, CSS, discrete webpage content (such as images, text, videos, files), etc.

Navigation: occurs when a user requests a webpage through a web client. The web client initially places an HTTP request for the webpage and displays the received webpage. The user navigates (or visits) the webpage. When the user clicks on a link in that webpage, the web client generates another HTTP request for another webpage corresponding to the clicked link. Various other user actions can result in the web client generating an HTTP request for another webpage. The whole session may be called a website visit. Users can navigate between webpages in predictable and unpredictable ways. A user could access the home page of a website, and select a link from that page to another page within the website. Another user could use a bookmark or enter a URL into a Web browser to access a webpage directly. Yet another user could select a link to a webpage in search results provided by a particular website or by an Internet search engine. While in most cases navigation refers to requesting different webpages in sequence, in some cases navigation may refer to navigating to the same webpage twice in sequence. For example, a webpage may contain a link to itself, or another feature that when accessed, causes the web client to place another primary HTTP request for the same webpage. A user would not typically navigate twice in sequence to the same webpage, but a user might navigate to the same webpage multiple times during the same session.

JavaScript (a.k.a. script) and AJAX: webpage contents can contain webpage processing code in the form of instructions of a web scripting language, most commonly a JavaScript. Various system and user events, such as the web client completing loading of a webpage or a user clicking on a webpage content, can control the execution of the web client and can trigger the execution of a JavaScript that controls the behavior of the web client, including Asynchronous JavaScript and XML (AJAX). AJAX refers to using logic in the webpage to place HTTP requests and process responses to the requests, instead of having the web client load the responses directly. A web server or web analytics server responds to HTTP requests from AJAX components with XML, code, or data in other formats. The webpage content placing the AJAX HTTP request can process the data or execute the code returned from the web server, such as to update the user interface shown on the webpage. It is possible for the user to disable JavaScript in most types of web clients.

Action and Event: actions and events are elements that can be monitored during a website visit. An action represents a user activity with respect to a webpage content of a webpage. A user action raises an event. An event represents something that happened with respect to a webpage content of a webpage, such as the user action of clicking a button component, or a multimedia component reaching the end of a video. Events with respect to webpage content can cause the web client to place additional HTTP requests that do not cause the web client to load a new webpage, but instead update webpage content of the current webpage, or record a user action.

Session (a.k.a. web session): sequence of interactions between a web client and a web server, such as a series of webpages views (web client perspective) on the web server accessed by the web client by a single website visitor as a continuous process. The definition of continuous process differs from one monitoring application to another. It could be defined based on opening and closing of a first and last webpage of the website, as a period of inactivity (a.k.a. without request communicated by the web client to the web server), as terminating the execution of the web client, etc.

Cookie: a cookie is a dataset that can be stored on a user device under the control of a web client. A web cookie is adapted to collect and/or store data later communicated to a web server, such as a unique identifier of the web client. Following is an example of use of a cookie. When a web client requests a resource from a web server, the response can include a cookie. The web client includes that cookie in subsequent requests to the same web server. Each cookie is associated with a domain (possibly including a subdomain), and the web client only transmits the cookie when requesting a URL in the same domain from which originates the cookie. A cookie can include various types of information, including a token that uniquely identifies a user or the web client. Some types of web clients do not support cookies. It is also possible for a user to prevent a web client from accepting cookies and for cleaning cookies from a memory of the device on which the web client is executed. However, a large portion of websites do not work properly when the user disables the acceptation of cookies in the web client. Web clients may support session cookies, which disappear when the user closes the web client, and permanent cookies, which persist across multiple sessions. Alternatives to cookies exist, such as the use of HTML5 local storage on web clients. A cookie is also a processing code (e.g. a JavaScript) comprising instructions that can be executed by a processor of a device under the control of a web client running on the device. In the rest of the description, the term cookie will refer to a cookie consisting of a dataset and the term Internet cookie will refer to a cookie consisting of processing code. The execution of instructions of an Internet cookie may generate data which are stored in a cookie.

URL, Protocol, Domain, Path, and Query String Parameters: A URL identifies a resource on a web server. A URL includes (without always being specifically stated) a web protocol specification and a domain. It can include a top-level domain, a subdomain, a port, a path, an extension, any number of query string parameters, an anchor, and various characters used to separate these tokens. For example, in the URL http://www.domain.tld:port/path/to/resource.html?key1=value1&key2=value2#anchor:

http represents a web protocol specification.

www represents a subdomain within a domain.

domain represents a domain.

tld represents a top-level domain.

port represents a communication port to be used by the TCP/IP protocol.

/path/to/resource represents a path of access of the resource.

html represents an extension.

The question mark character (“?”) separates the path from the query string parameters.

key1 represents the name of a query string parameter.

value1 represents the value of the query string parameter named key1.

key2 represents the name of a query string parameter.

value2 represents the value of the query string parameter named key2.

anchor represents an anchor identifier.

All other characters separate these various tokens.

URLs can have additional properties than described above and are well described in various Internet RFCs.

Application Programming Interface (API): an Application Programming Interface, or API, defines conventions for a computer programming language, by which a software program accesses features of another software system.

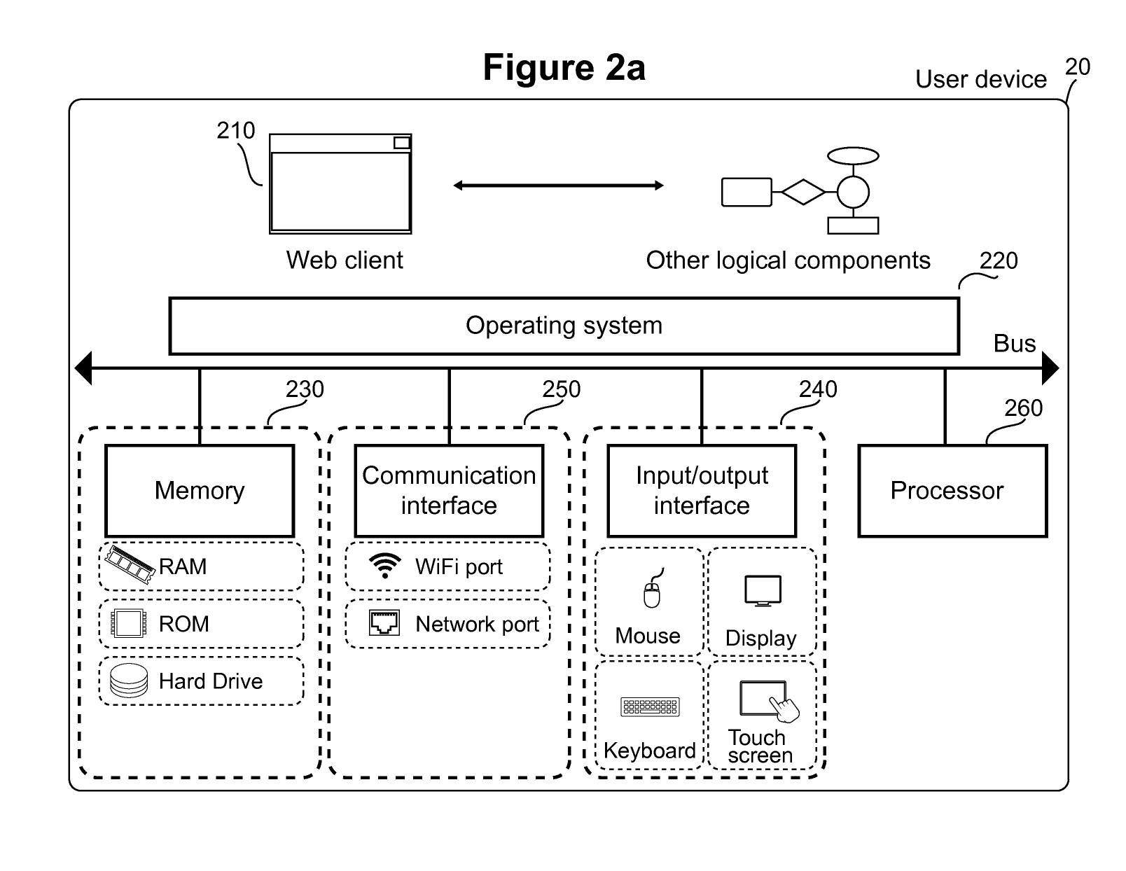

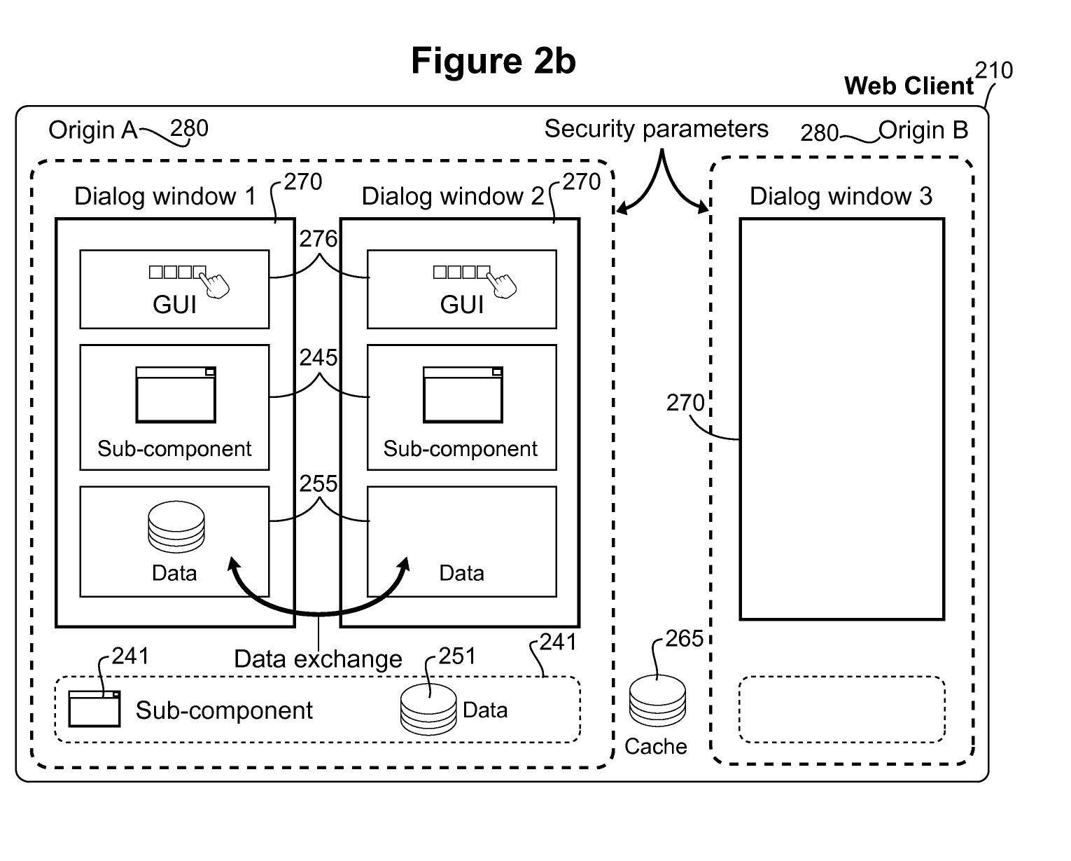

Reference is now made concurrently to FIGS. 1 and 2a. FIG. 2a illustrates an example of a generic-purpose user device 20 hosting a web client 210. The user device 20 comprises hardware components and software components. The software components are generated when a user device processing system 260 processes codes or instructions stored on memory 230 associated therewith. The processing system 260 may comprise one or several processors, each processor including one or several cores. As illustrated, the user device 20 hosts a web client 210. The web client 210 may either be manufactured with the user device 20, or the web client 210 may be installed later. The illustrated web client 210 may consist in a web browser such as Microsoft Internet Explorer™, Google Chrome™, Apple Safari™ or Mozilla Firefox™, etc. Other web clients 210 customized for specific tasks and/or processes and designed to communicate with specific servers, may be available such as those developed under the Adobe Integrated Runtime (AIR) or Windows Runtime (WinRT) environment. The web client 210 further provides the necessary environment for the user device 20 to process webpage content received from the web server 30. The web client 210 also allows: i) to generate an interface (for example a webpage) resulting from the processing of the webpage content, and ii) to process instructions that are embedded in the webpage content (examples of embedded instructions may consist in scripts), and generate software sub-components that run according to the runtime environment provided by the web client 210. The web client 210 s will be further detailed in relation with FIG. 2b.

The user device 20 may also include logical components such as software components. The web client 210 and the other software components are supported by an operating system 220 providing the necessary runtime environment and bridging the software components with the hardware components when necessary. The user device 20 comprises the following hardware components (as illustrated in FIG. 2a): the processing system 260, memory 230, an input/output interface 240 and a communications interface 250 (for communicating over a network). The web client 210 is designed to interact with the hardware components in a functional manner through the operating system 220, for instance to access memory 230 for reading and writing purposes, to communicate with remote processing system-based devices via the communications interface 250, to display information, and to receive input from the user via the input/output interface 240 (for instance through keyboard and mouse controls).

The exemplary web client 210 is designed to generate requests, to receive webpage content corresponding to webpages of websites, and to display the webpages of these websites on a graphical user interface of the web client. A website visit is performed when the web client 210 exchanges data packets or messages with the web server 30. The data exchange is initiated by the web client 210 when a visit request is transmitted to the web server 30. The communication state that is initiated accordingly is called a session and is an ongoing session evolving as additional messages are exchanges between the web server 30 and the web client 210. The session further takes place according to an “origin identifier”: a combination of protocol and Uniform Resource Location (URL) used to establish security policies to apply on the web client 210 in relation with resource sharing, such as cookie data exchange. The concept of origin identifier and security policy is further explained below.

During the ongoing session, the web client 210 receives webpage content from the web server 30 in response to a request to the web server 30, and processes the received webpage content, such as HTML documents, provided by the web server 30. Following the processing of the received webpage content, the web client 210 displays the received webpage content requested in dialog windows 270.

The web client 210 further provides the necessary runtime environment for software sub-components to be generated when the received webpage content includes embedded instructions (e.g. scripts). The resulting software sub-components run according to the runtime environment, parameters and security policies of the web client 210, as sub-components of the web client 210. An origin identifier 280 is a key element for discriminating security parameters in relation with security parameters applicable to cookies. Other elements, such as protocol, domain, and other features are used for determining security parameters in relation with other features such as the HTML5 local storage discussed above. Thus, while running according to the web client 210 parameters, the software sub-components are also provided with similar capabilities (ex. communication capabilities and hardware access capabilities) as the web client 210. The web client 210 is also adapted to apply security policies parameters in relation with the provided runtime environment. The security policies, for instance, limit 1) information accessibility and 2) processes according to origin identifier 280, therefore isolating data relative to a first dialog window 270 with respect to a first origin identifier 280 from another dialog window 270 with respect to another origin identifier 280. Software sub-components generated according to one origin identifier 280 are not allowed to interact with any content relative to another origin identifier 280.

In the context of the present disclosure, Origin identifier must be understood based on the World Wide Web Consortium (W3C) definition of the “Same Origin Policy” available at http://www.w3.org/Security/wiki/Same_Origin_Policy. The Origin identifier is the concept on which is based the “Same Origin Policy”; namely a combination of a communication protocol or other communication parameters, and a Uniform Resource Locator (URL). An example of an Origin identifier may be http://www.iperception.com. The other webpages of the same website such as http://www.iperceptions.com/portal/ share the same Origin identifier. The origin identifier is an identification of the origin associated with an ongoing session. The origin identifier is a key parameter defining how a web client handles security parameters, such as software sub-component permissions, the management of cookies, etc. The World Wide Web Consortium (W3C) defines in its “webpage content accessibility guidelines wcag” the term origin as follow: an origin is defined by the scheme, host, and port of a URL.

The web client 210 is further designed to store in memory 230, according to runtime environment policies, codes such as Internet cookies. In relation with the graphical user interface provided by the web client 210, one or more dialog windows 270 may be present per origin identifier 280 during an ongoing session. The number of dialog windows 270 per origin identifier 280 during an ongoing session may vary, for instance based on requests of the user to open a new dialog window 270, to close an existing dialog window 270, or according to instructions embedded in the processed webpage content. The security restrictions and runtime environment provided by the web client 210 allow keeping data in association with dialog windows 270 (e.g. data 255) or with origin identifier 280 (e.g. data 251) compartmentalized. The security policies and runtime environment provided by the web client 210 generate sub-components 241 and 245 associated with the origin identifier 280 that may be specific to dialog windows 270. The dialog windows 270 are either or not part of the same browsing session, based on the domain identifier 280 associated therewith. They need to be associated with the same origin identifier 280 to be part of the same ongoing session. However, a new session associated with a new origin identifier 280 may be opened or initiated during a first ongoing session, without ending the first ongoing session.

The origin identifier 280 establishes security parameters. It isolates data and sub-components that pertain to one ongoing session from another ongoing session, based on the origin identifier 280 rather than on a graphical representation (e.g. the generated dialog windows 270).

The web client 210 also comprises a cache 265 that may be used to store webpage content. When a website visit request is generated, the web client 210 may retrieve from the cache 265 webpage content collected during a previous session, thereby decreasing the volume of webpage content necessary to be requested by the user device 20 and received from the web server 30 during a current ongoing session. The object of the cache 265 is mainly to accelerate webpage display by decreasing the needs of data exchange between the web client 210 and the web server 30.

Internet cookies are examples of software sub-components comprising instructions executed by the processing system 260 according to the runtime environment provided by the web client 210. To run Internet cookies, the processing system 260 may need to access the memory 230, use the communications interface 250 to send and receive data packets, and rely on the input/output interface 240 to obtain inputs from the user, display webpages (resulting from the processing of webpage content) on a display of the user device 20, etc. All these resources are available to the Internet cookies through the runtime environment provided by the web client 210.

The webpage content received from the web server 3, includes at least one of: 1) HTML documents, 2) Content Style Sheets (CSS) capable of providing display layouts and rules used to determine the layout for generating a webpage to be displayed, and 3) discrete webpage content to be integrated interchangeably in the displayed webpage according to a determined location of the webpage (thereby independently from a webpage structure provided by the HTML document and the Content Style Sheet). Examples of discrete webpage content include text elements, images, sounds, videos and animations, etc. Therefore, the displayed webpage is the result from the processing of these different kinds of webpage content.

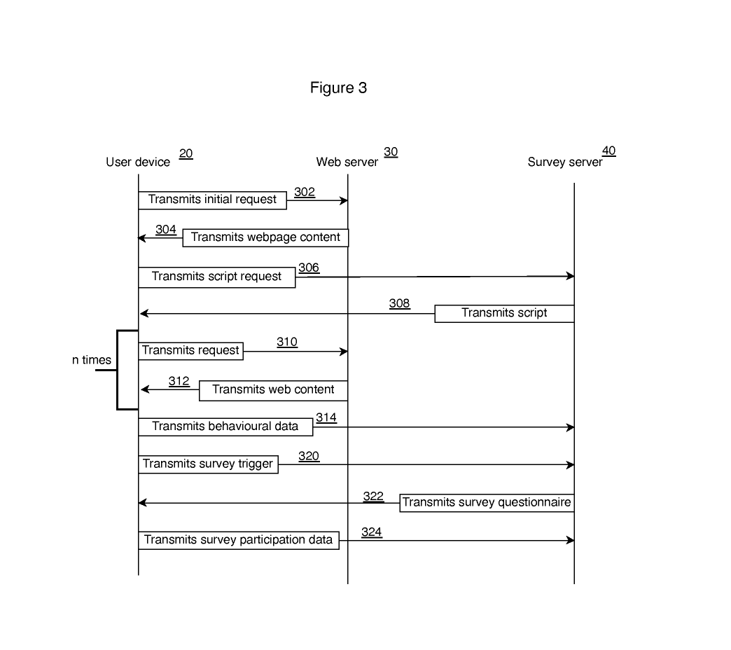

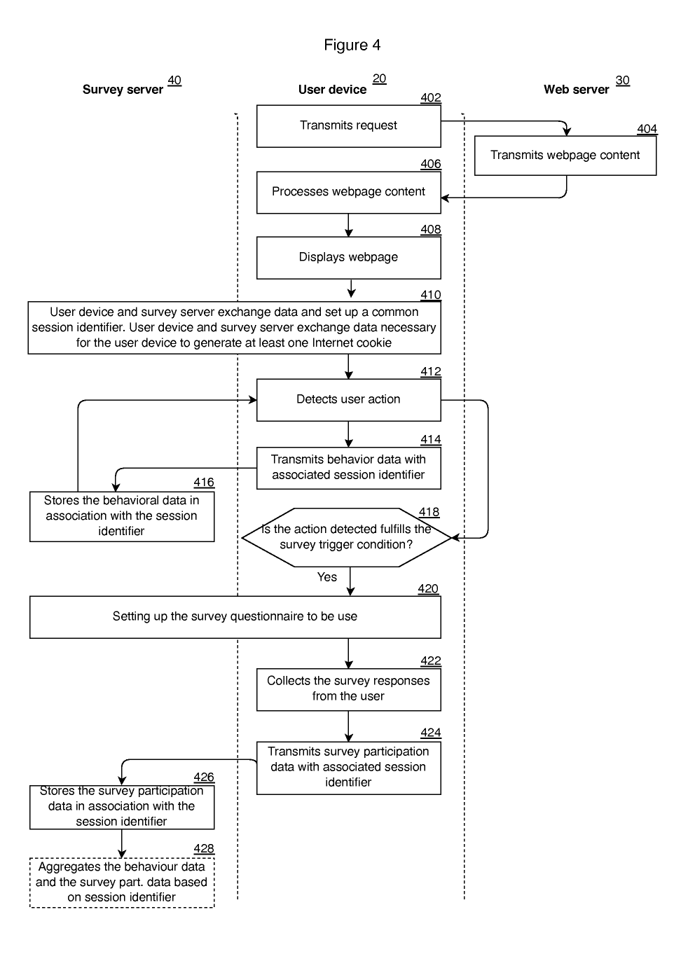

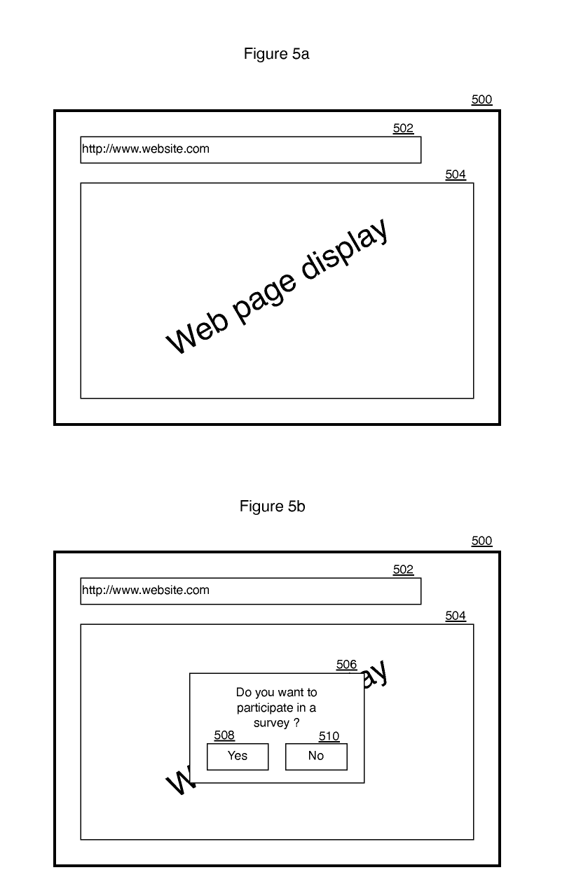

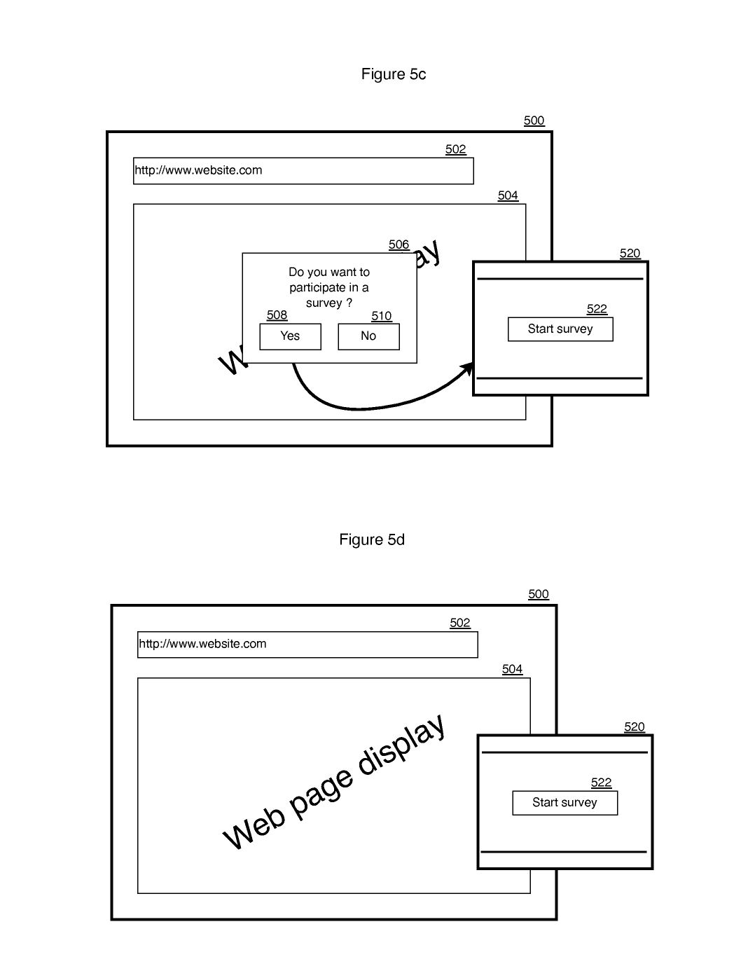

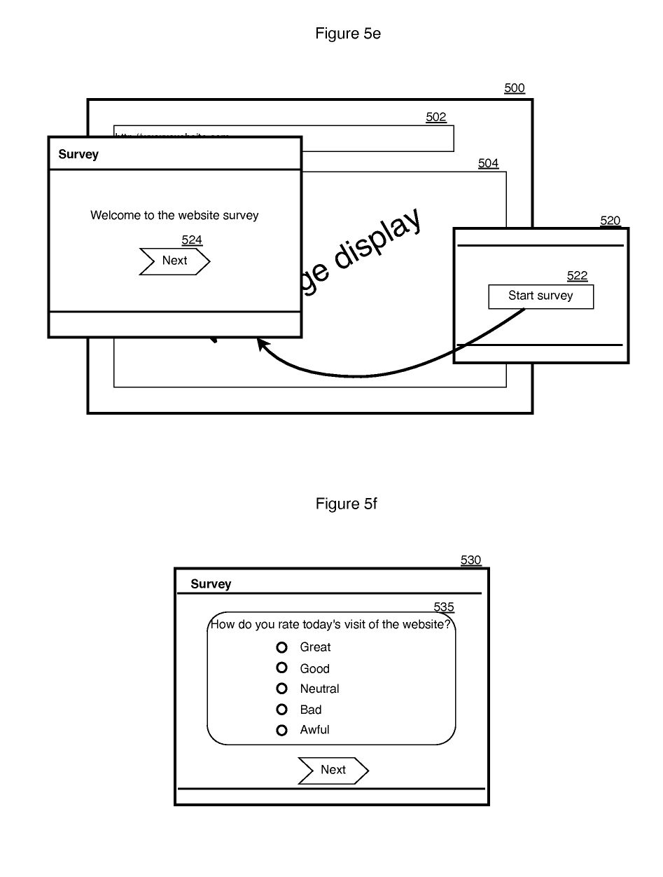

Referring now additionally to FIG. 3, FIG. 4, FIGS. 5a to 5f, FIG. 6 and FIG. 7, there are provided flow diagrams servers, flow of user displays to assist in illustrating the present and methods for generating predictive patterns for website analysis.

The present servers and methods collect data pertaining to user devices 20, wherein a server collects data and identifies the data as pertaining to a specific user device 20. The collected data pertaining to a specific user device 20 may comprise survey participation data, behavioral data and contextual data. When two kinds of data are received and they pertain to the same user device 20, they are identified as pertaining to a common user device 20, or being related.

Survey participation data may include comments and feedback received from website visitors (users of devices and/or or web client), which are the result of voluntary actions from the website visitors. An example of survey participation data comprise responses to a survey questionnaire communicated to the website visitor, either in the form of free-form text, ratings, selection of one or more elements among proposed alternatives, ordering of proposed elements, etc. An invitation to participate in the survey questionnaire may be prompted to the website visitor during the website visit, may be voluntarily triggered by the website visitor through the selection of an icon for instance, or may be communicated to the website visitor in a delayed manner, for instance through an email. When survey participation is conducted through an email process, the survey-related data transmitted to the survey server 40 include survey participation data and data permitting to identify the user device 20 which triggered the survey participation, and therefore to which pertains the survey participation data. A survey questionnaire may also consist in a voluntary comment provided by the website visitor through the use of a comment form that may be triggered through different techniques, or through a chat window for instance. These examples are for illustration purposes only, and should not be understood as an exhaustive listing.

Behavioral data comprise one or more data indicative of actions performed and events taking place in relation with a visit of the website by a user of the user device (and/or web client thereof) 210. Examples of behavioral data include a list of URLs visited, a time spent on visiting webpages, an event taking place following an action such as scrolling down a webpage, activation of a control present in a webpage, submission of a completed form, initiation of the play of a music file or a video, initiation of an interactive content, etc. These examples are for illustration purposes only, and should not be understood as an exhaustive listing.

Contextual data may include any data that can be collected in an automated manner, and that reflects the environment in which the website visit is performed. Accordingly, contextual data refers to normally unchanging conditions and settings that remain the same through the whole website visit, such as hardware configuration, software configuration, user device configuration user preferences, etc. Examples of contextual data include, in a non-limiting manner, the type and/or version of web client 210, settings present on the web client 210 such as language settings, data regarding the user device 20 such as the type of user device 20 (a mobile phone, a tablet, a laptop or desktop computer, etc.), display definition of the user device 20, IP address used by the user device 20 for Internet communication, user device 20 local time and/or time zone, web client 210 installed add-ons, etc. These examples are for illustration purposes only, and should not be understood as an exhaustive listing.

To collect behavioral data and/or contextual data to be associated with survey participation data, the present servers and methods encompass the use of a tool: an Internet cookie with a monitoring functionality, generated according to the processing of an embedded script, which monitors the behavior of the user of the device in relation with the content of the webpage. That embedded script is either in the webpage or is transmitted to, or retrieved by, the web client 210. FIG. 3 illustrates the flow of an exemplary exchange of data between the web client 210 of the user device 20, the web server 30 and a survey server 40. In the example, the survey server 40 exchanges data with the user device 20 in an asynchronous manner. The data exchange is performed in the background of the standard website visit process (webpage generation, webpage controls activation for collecting actions from the website visitor, transmission of requests to the web server 30, etc.). Data exchanges take place between the user device 20 and the survey server 40 without interrupting, or with minimal influence over the website visit process. The monitoring functionality of the Internet cookie may also monitor contextual data. Thus, the monitoring functionality may comprise only the behavioral functionality for monitoring behavioral data, or a combination of the behavioral and contextual functionalities.

An example of processing of the embedded script results is illustrated on FIGS. 5a to 5f as the opening of an additional window by the web client 210 through which an invitation is provided to the user of the device to respond to a survey at the end of the session. FIG. 5a illustrates an exemplary main graphical user interface 500 of the web client 210, wherein an address window 502 and a webpage window 504 are displayed. FIG. 5b illustrates the interface 500 once the invitation process is initiated, which is illustrated as an invitation window 506 displayed over the webpage window 504. The invitation window 506 features controls 508 and 510 allowing the website visitor to express a decision to accept (via control 508) or to refuse (via control 510) to participate in the survey. As illustrated on FIG. 5c, the acceptation to participate in the survey results in the invitation window 506 being replaced by a survey monitor window 520 featuring a survey initiation control 522. As illustrated on FIG. 5d, the survey monitor window 520 goes in the background and is hidden by the web client main interface 500. As illustrated on FIG. 5e, the survey monitor window 520 is replaced by a survey window 530 when either the website visitor activates the survey initiation control 522 or when a survey trigger is detected (for instance when the webpage widow 504 associated with the website is closed). Now referring to FIG. 5f, the survey window 530 is illustrated with a questionnaire 535 illustrating how the user may participate in the survey.

Referring back to FIG. 3, the communication exchanges taking place during a website visit between the user device 20, the web server 30 and the survey server 40 are illustrated.

At step 302, the user device 20 transmits a request to the web server 30. The request identifies a requested webpage of a website associated with an address, or in other words a request to visit the webpage of the website.

At step 304, the web server 30 responds by transmitting the webpage content to the user device 20. The webpage content comprises the necessary information for the web client 210 of the user device 20 to generate and display the webpage. It further comprises either a script for getting additional information from the survey server 40, and/or a script to directly generate based on the available information an Internet cookie to perform processes in relation with the ongoing website visit.

At step 306, the user device 20, under the control of the script, transmits a request to the survey server 40 for script data. This step takes place when the embedded script does not contain all the necessary code for the desired Internet cookie to be generated. This step also includes a communication initiation process wherein the user device 20 and the survey server 40 exchange data to set up the communication configuration (cookie data, address, identifier, survey invitation status, delay settings, etc.) for the website visit. Although the survey server 40 is shown as a separate entity of the web server 30, both servers could be co-located.

Step 308 illustrates the transmission of the requested data by the survey server 40 to the user device 20 in response to the request of step 306.

Although step 306 and step 308 are illustrated for simplification purposes as a single request/response for exchanging data, one or more of these exchanges of data may take place at different stages of the website visit.

At step 310, the user device 20 reacts to actions of the user resulting in the transmission of a new request to the web server 30. That request may be associated with a new webpage, or may involve actions without changing the displayed webpage (see definitions of actions and events for reference).

At step 312, the web server 30 responds to the request received at step 310 and transmits requested webpage content to the user device 20.

At step 314, the user device 20, under the control of the Internet cookie with the monitoring functionality, transmits collected behavioral data to the survey server 40. Examples of behavioral data herein transmitted include identification of a new URL, activation of a control on the webpage, webpage scrolling information, browsing duration, etc.

Although step 310, step 312 and step 314 have been illustrated and described in combination, conditions and alternatives may result in having them not always combined. For instance, step 314 may take place without being preceded by step 310 and step 312. On the other hand, the Internet cookie with the monitoring functionality may collect a pre-defined volume of data before having the user device 20 communicating the collected behavioral data to the survey server 40, potentially resulting in step 314 not always following step 310 or a combination of step 310 and step 312.

At step 320, following the detection by the Internet cookie with monitoring functionality of a survey trigger (for instance upon occurrence of the activation of the survey initiation control 522 illustrated on FIG. 5e), the user device 20 transmits the survey trigger information to the survey server 40.

At step 322, the survey server 40 transmits to the user device 20 the survey questionnaire for the website visitor to participate in the survey.

At step 324, the user device 20, after the website visitor having responded to the questionnaire or along with the reception of the responses to the survey questionnaire, transmits the survey participation data (survey responses in an appropriate format) to the survey server 40.

Although the data exchanges illustrated at steps 322 and 324 involve a single transmission of the survey questionnaire and the survey participation data, a plurality of transmissions may occur, so that smaller packets of data are transmitted more frequently by either one or both of the user device 20 and the survey server 40.

Now referring to FIG. 4 in light of the other Figures another flow chart is described involving steps performed by the user device 20, the web server 30 and the survey server 40.

At step 402 (corresponding to step 302 on FIG. 3), the user device 20 transmits a request to a web server 30. The request is typically transmitted according to the TCP/IP protocol, but other communication protocols may alternately be used. The request further comprises an origin identifier. The origin identifier corresponds to the identifier used by the user device 20, the web server 30 and the survey server 40 to identify the origin of the request, and all subsequent related communications and associated communication parameters (such as the communication protocol applied).

At step 404 (corresponding to step 304 on FIG. 3), the web server 30 receives the request from the user device 20, and transmits in response thereto corresponding webpage content to the user device 20. The webpage content comprises an embedded script used to generate one or more Internet cookies.

At step 406, the web client 210 of the user device 20 receives the webpage content and processes the received webpage content. Processing of the received webpage content by the web client 210 includes processing the HTML document, the Content Style Sheet (when applicable), discrete webpage content (when applicable) and embedded script(s).

At step 408, the user device 20 displays the generated webpage according to the visual environment and runtime environment provided by the web client 210.

At step 410, the user device 20 generates (via the script embedded in the webpage content) the Internet cookie with survey functionality and a behavioral functionality. That step may involve a series of data exchanges between the user device 20 and the survey server 40. The Internet cookie, thereafter, agree, along with the survey server 40, on a session identifier to be used for data communication between the Internet cookie and the survey server 40. The session identifier may alternatively be set by the web client 210 of the user device 20, by the survey server 40 and transmitted to the user device 20, or transmitted by an independent source. The session identifier may also either have another source or may be shared with other components or devices, or used in relation with other functionalities. One example of one of these alternatives may consist in using the session identifier used by the web server 30, or a third-party session identifier. Furthermore, the session identifier may be set uniquely for an ongoing session and cleared at the end of the ongoing session, or the session identifier may be used in a more persistent manner to link collected data over multiple ongoing sessions.

The script embedded in the webpage content associated with the webpage may consist in a script (hereinafter referred as a gateway script) as described in FIG. 3. The gateway script is a set of instructions which, when executed by the processing system 260 of the user device 20 according to the web client 210 runtime environment, generates a sub-component having as principal functionality to open a communication channel and to provide a favorable environment through which the web client 210 receives additional new scripts to process and therefore generate new sub-components according to the same origin identifier. For example, the gateway script is used to open a communication session between the web client 210 and the survey server 40 for transmitting a survey script. The survey script, once received by the web client 210, is processed according to the web client 210 runtime environment and a corresponding Internet cookie with a survey functionality is generated. That Internet cookie with the survey functionality runs according to the origin identifier associated with the webpage in which the gateway script was embedded. The gateway script allows additional sub-components to be generated and to run according to the origin identifier associated with the same ongoing session.

Accordingly, step 410 is intended to describe both situations: when the script for generating the necessary sub-components is initially embedded in the webpage content, as well as alternatives requiring additional data exchanges or data extraction from a different storage location.

The gateway script and other sub-components such as the Internet cookie with the survey functionality and the behavioral functionality are executed concurrently with generating and displaying the webpages, thus minimizing the delays in presenting the desired webpage content to the user of the user device 20. These functionalities of the Internet cookie are designed to have minimal interaction with the user interface of the user device 20, thus taking advantage of times when the web client 210 presents low processing and communication requirements.

Accordingly, step 402 to step 410 may correspond to the initiation of a website browsing session.

At step 412, once the webpage is displayed, the behavioral functionality of the Internet cookie for monitoring behavioral data is initiated. Behavioral data are monitored and collected as actions take place in relation with the displayed webpage. As previously discussed, contextual data may also be monitored and collected as actions take place in relation with the displayed webpage, via the contextual functionality of the Internet cookie.

Not illustrated through the present flow chart, but described in relation with FIGS. 5a to 5f, the survey functionality of the Internet cookie at this step determines if the user device 20 should solicit participation of the user of the user device in a survey or not, with display of an invitation window in case of a positive determination.

At step 414 (corresponding to step 314 on FIG. 3), the behavioral functionality of the Internet cookie transmits the monitored behavioral data (data indicative of the monitored events resulting from user actions) to the survey server 40 along with the session identifier. The monitored data may include specific contextual data, as collected by the contextual functionality of the Internet cookie, which are also transmitted to the survey server 40 along with the session identifier.

At step 416, the survey server 40 stores the received behavioral data, aggregating the received behavioral data with respect to the session identifier, to generate an aggregate of the monitored behavior of a unique web client 210 of a user device 20 according to a continuous ongoing session, distinct from the behavior of other web clients 210 associated with other user devices 20.

The behavioral functionality of the Internet cookie may monitor all dialog windows sharing the same origin identifier, or according to an alternative, may monitor only user-driven interactions and events occurring in relation with a principal dialog window.

The behavioral data is transmitted as monitored, or aggregated in packets and transmitted in a scheduled manner, or aggregated in packets and transmitted based on other detectable triggers such as for example time-based or packet-size based criteria. The selection of one alternative versus another is a design decision.

At step 418, the survey functionality of the Internet cookie determines if the survey trigger condition is fulfilled or not. As long as the condition is not fulfilled, no survey participation is initiated.

The link represented in FIG. 4 from step 416 to step 412 illustrates that the user of the user device 20, during the course of the ongoing session, may generate other webpage requests, receive additional webpage content and display webpages as previously mentioned. The generation of new requests and display of additional webpages is part of an unpredictable process wherein the website visitor determines the series of webpages requested (hence visited), the events taking place, etc.

It may occur that the additional webpage content received from the web server 30 may comprise embedded scripts. In this instance, a verification is made by the processing system 260 of the user device 20 to determine whether the sub-components that would result from processing the embedded scripts are already running, based for instance on cookie information and unique identifier, to prevent duplicating sub-components and functionalities or increasing unnecessarily requirements from the web client 210.

At step 420 (corresponding to step 320 on FIG. 3), once the survey functionality of the Internet cookie confirms fulfillment of the survey trigger condition, a survey initiation process takes place. During that process, according to data initially included in previous data exchanges and in the embedded script, the user device 20 and the survey server 40 exchange data to agree on the initiation of the survey process, including a determination of a questionnaire to be used for a participation in the survey by the website visitor.

At step 422, the user device displays interfaces featuring questions to the user, and collects responses provided by the user of the user device to these questions. The collected responses are the survey participation data, in the original format in which they have been collected, or in another more appropriate format for transmission.

At step 424 (corresponding to step 324 on FIG. 3), the survey functionality of the Internet cookie transmits the resulting collected survey participation data, along with the session identifier, to the survey server 40, for aggregation.

At step 426, the survey server 40 receives and stores the survey participation data.

At step 428, the survey server 40 aggregates the survey participation data and the related behavioral data with respect to their associated session identifier. If contextual data have been transmitted to the survey server 40, they are also related with respect as a function of their associated session identifier.

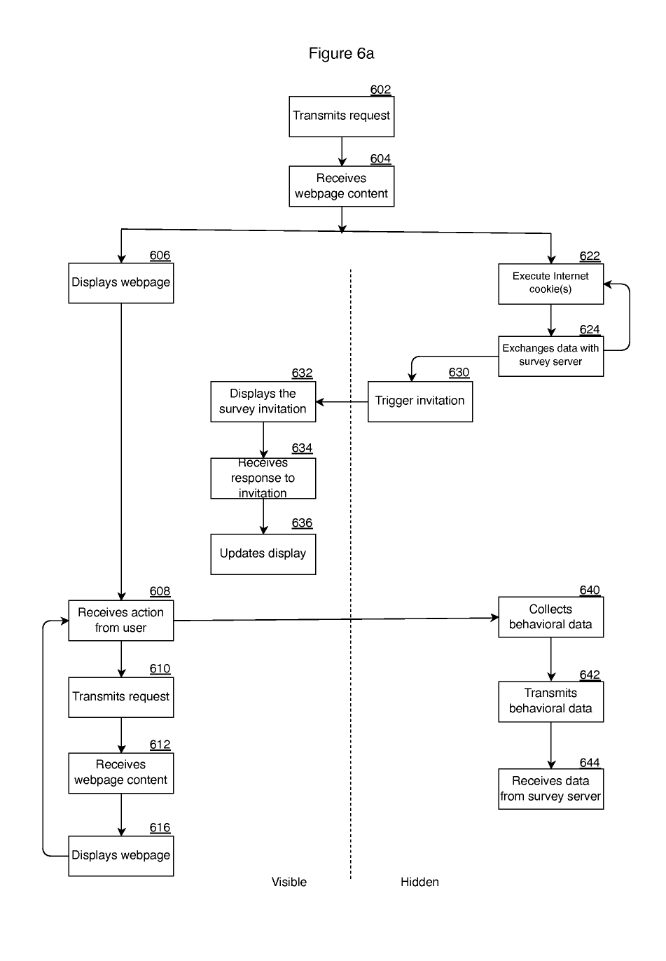

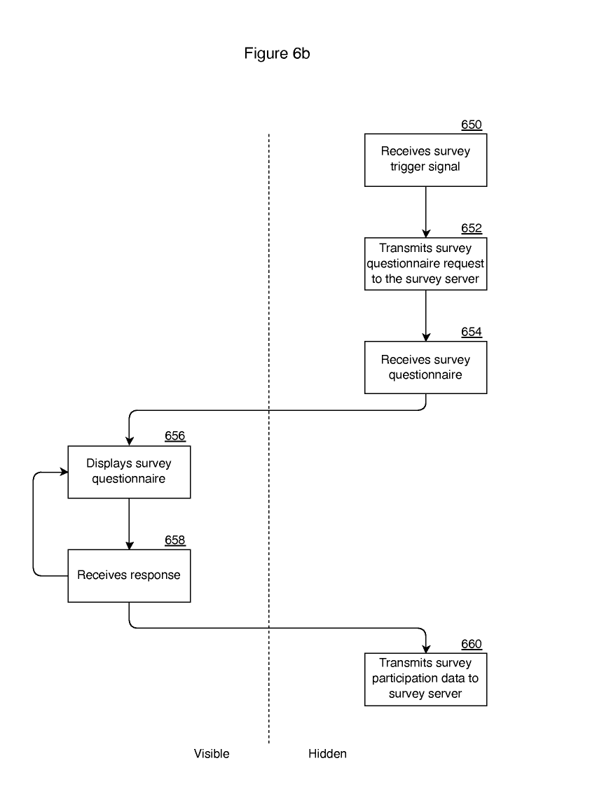

Now referring to FIG. 6a and FIG. 6b in light of the other Figures, a flow chart illustrating steps performed by the user device 20 is represented.

Referring to step 602 (corresponding to step 302 on FIG. 3), the user device 20 under control of the user, transmits a request to the web server 30. As stated before, the user may request to visit a webpage of a website, which results in the transmission of the request to the web server 30.

At step 604, the user device 20 receives webpage content from the web server 30.

At step 606, the processing system 260 of the user device 20, under the control of the web client 210 and according to the runtime environment provided by the web client 210, processes a portion of the received webpage content related to the webpage, generates the resulting webpage and displays the generated webpage.

At step 622, the processing system 260, under the control of the web client 210, processes one or more Internet cookies to perform security policies imposed by the web client 210.

At step 624, the user device 20 exchanges data with the survey server 40, either to receive the codes necessary to generate the at least one Internet cookie or to set up configuration of the at least one Internet cookie for the corresponding website visit. This step may include the exchange of cookie information between the user device 20 and the survey server 40, and further store or update of cookie information in the memory 230 of the user device 20.

At step 608, the web client 210 receives action(s) from the user.

At step 610, the action triggers the transmission by the user device 20 of a request (corresponding to step 306 on FIG. 3) to the web server 30.

At step 612, the user device 20 receives webpage content in response to the request of step 610.

At step 616, the user device 20, under the control of the web client 210 and according to the runtime environment provided by the web client 210, processes the newly received webpage content, and displays a resulting new representation of the webpage or updates the representation of the webpage according to the received webpage content.

At step 630, at a certain stage in the process, herein illustrated after step 606, the survey functionality of the Internet cookie triggers the survey invitation process.

At step 632, as illustrated through FIGS. 5a to 5f, a survey invitation window 506 is displayed over the webpage window 504.

At step 634, a response to the invitation is received from the user. The response is collected by the survey functionality of the Internet cookie which, depending on the response of the user of the device, may be turned off (negative response) or may be turned into an idle mode at step 638 (waiting for a signal to trigger the survey participation process).

At step 636, as illustrated through FIGS. 5a to 5f, the survey invitation window 506 is replaced by a survey monitor window 520 placed in the background to become non-obtrusive.

At step 638, the survey functionality of the Internet cookie is placed into the idle mode, waiting for the survey triggering condition to be fulfilled to start again taking an active role in the process.

At step 640, the monitoring functionality of the Internet cookie collects behavioral data (and optionally contextual data) from the web client 210. The behavioral data result from actions performed by the user when interacting with the displayed webpage, and more particularly with the series of actions performed by the user during the corresponding website visit.

At step 642 (corresponding to step 314 on FIG. 3), the user device 20, under the control of the monitoring functionality of the Internet cookie 210, transmits behavioral data (and optionally contextual data) to the survey server 40.

At step 644, the monitoring functionality if the Internet cookie receives data from the survey server 40, for instance acknowledgement for the behavioral data (and optionally contextual data) sent at step 622.

At step 650, the survey functionality of the Internet cookie receives the survey trigger signal. For instance, the trigger signal may be the user activating the survey control. Alternatively, the trigger signal may be the user closing a main window displaying a webpage of the website. In another alternative, the duration of the visit of the website or the duration of the visit of particular webpage of the website may trigger the survey.

At step 652, the survey functionality of the Internet cookie may communicate with the survey server 40 to request information related to a survey questionnaire to be used for the survey. The data transmitted also inform the survey server 40 (as illustrated at step 320 on FIG. 3), that the survey is triggered.

At step 654, the survey functionality of the Internet cookie receives the survey questionnaire to use for the survey participation.

As stated earlier, step 654 may be divided into a series of iterations of the above steps, through a period of time that may begin before the trigger of the survey, and that may also end before the trigger of the survey. Advantage may be taken of a low-usage of the processing system 260 of the user device 20 during the website visit to exchange data and build the survey questionnaire in the memory 230 of the user device 20.

At step 656, the survey functionality of the Internet cookie orders the web client 210 to generate and display a question of the questionnaire in a window as illustrated on FIG. 5f.

At step 658, the web client 210 receives the user response to the displayed question and communicates the response to the survey functionality of the Internet cookie. As illustrated on FIG. 5f, one question may be presented at a time. However, more than one question may be provided in the same window. The format in which the questionnaire is presented to the user is only a question of design. Furthermore, according to design decisions, to the questionnaire length, etc., step 656 and step 658 consisting of displaying a question and receiving the user response to that question may be repeated multiple times.

At step 660, survey participating data (consisting of a response to a question at a time, multiples responses to multiple questions, or responses to the whole questionnaire) are communicated to the survey functionality of the Internet cookie, and the survey functionality of the Internet cookie transmits the survey participation data to the survey server 40.

After that step, when all of the survey participation data are transmitted to the survey server 40, the survey functionality of the Internet cookie may be deactivated and removed from the memory 230 of the user device 20.

The above steps are described in relation with the user accepting to participate in the survey. In case of the user refusing to participate in the survey or no invitation being placed (based on random determination of participants, on a participation having already been collected from the web client 210, on the user device 20 being voluntarily excluded from participating in the survey according to one or more conditions such as geographic location, etc.), the webpage content may still be placed in the background, or another persistent webpage element may remain active regardless of the displayed webpage of the website, providing a link for the monitoring functionality of the Internet cookie to be able to collect behavioral data (and optionally contextual data) and transmit the behavioral data (and optionally contextual data) to the survey server 40. Therefore, one must understand that, regardless of the alternative of the survey participation being accepted or not, similar steps related to the collection of behavioral data may take place, even when not collecting survey participation data from the user device 20.

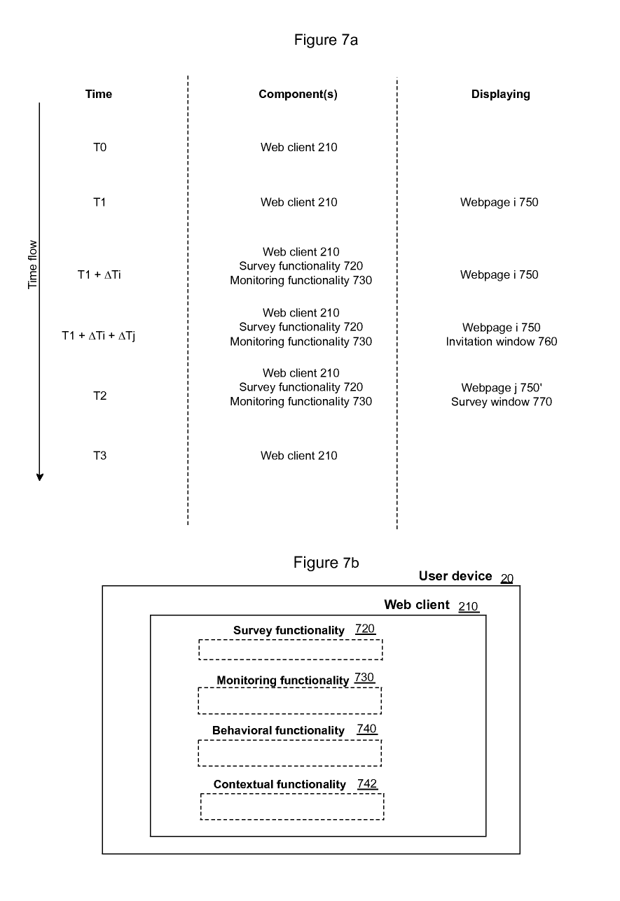

Reference is now made to FIG. 7a. FIG. 7a illustrates the exemplary lifetime of the aforementioned web client and functionalities running during the visit of a website. At TO, only the web client 210 exists on the user device 20. Following a request transmitted to the web server 30, a webpage 750 of the website is displayed, and a gateway script (not represented in the Figures) is activated if needed. Following, the survey functionality of the Internet cookie 720 and the monitoring functionality of the Internet cookie 730 are generated, and the gateway script is deactivated. The monitoring functionality 730 may comprise a behavioral functionality and optionally a contextual functionality. Following, (as illustrated on FIGS. 5a to 5f) an invitation window 760 is displayed. During the website visit, the webpage 750 may be replaced multiple times according to user interactions. When the survey is triggered, a webpage 750′ is displayed as the survey window. Finally, after the end of the visit, only the web client 210 remains active on the user device 20.

Reference is now made to FIG. 7b. FIG. 7b illustrates in a schematic manner the user device 20 comprising the web client 210, the survey functionality of the Internet cookie 720 and the monitoring functionality of the Internet cookie 730. The web client 210 is illustrated though solid lines since remaining in existence throughout the process. The survey functionality of the Internet cookie 720 and the monitoring functionality of the Internet cookie 730 are illustrated inside the web client 210 since operating according to the runtime environment provided by the web client 210, and in dashed lines since being generated and removed from memory of the device 20 at different steps of the process. Furthermore, the monitoring functionality 730 may comprise, the behavioral functionality 740 and optionally the contextual functionality 742 (shown separately for simplicity purposes). Each functionality 720, 730, 740 and 750 of the Internet cookie may be implemented via a single Internet cookie, or via two different Internet cookies. Similarly, if both functionalities 740 and 742 are present in the monitoring functionality 730, they may also be implemented via a single Internet cookie, or via two different Internet cookies.

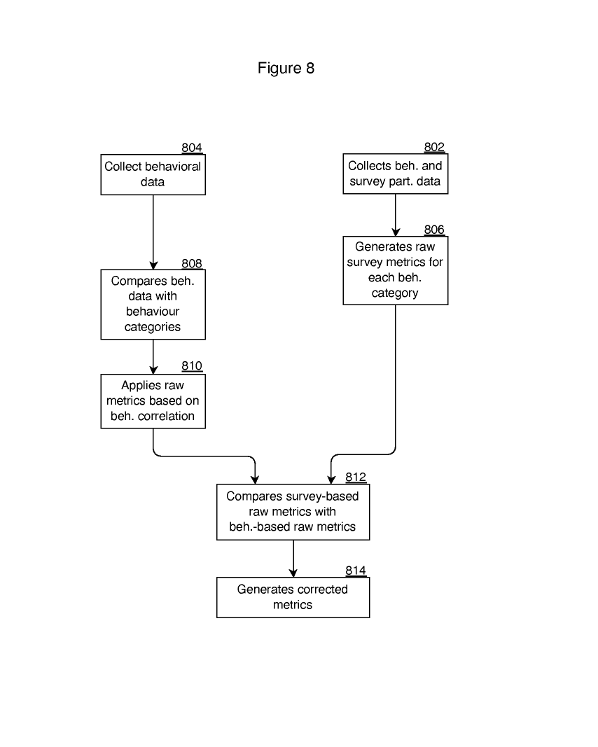

Now referring to FIG. 8, in light of the data flow described in relation with FIG. 3 and the flow chart of FIG. 4, a flow chart illustrating the steps performed by the survey server 40 (or an analytic server) with the data collected from the devices 20 is represented.

At step 802, the survey server 40 collects a combination of survey participation data and behavioral data from a plurality of user devices 20 visiting a website. Optionally, contextual data related to user devices 20 are also collected to enrich the collected survey participating data and behavioral data. The collected data may be stored in a database.

The survey participation data correspond to survey information entered by the users of each of the plurality of user devices 20 in relation to the visiting of the website. The behavioral data are representative of a series of actions performed by the users of each of the plurality of user devices 20 while visiting the website. The behavioral data include for instance a sequence of URLs of visited webpages, a duration of the webpage visits, scrolling data, control activation data, etc. The optional contextual data correspond to at least one of the following: hardware configuration, software configuration, user device configuration and user preferences (for instance user device type, web client type, language, and geographic location).

At step 804, the survey server 40 collects only behavioral data (and optionally contextual data) from user devices 20 that have been excluded from the survey, either by the survey server 40 or when the user of the user device 20 voluntarily refused to participate in the survey. Thus the survey server collects both behavioral data and survey participation data for some of the user devices, and only behavioral data from the other user devices.

At step 806, the survey server 40 analyzes the survey participation data and the related behavioral data collected at step 802 to generate predictive survey participation patterns. In the case where the optional contextual data are also collected, the analysis by the survey server 40 of the survey participation data and the related behavioral data further comprises analyzing the related collected contextual data, to generate the predictive survey participation patterns. The survey server 40 may determine that the survey participation data and the behavioral data collected at step 802 are related based on the session identifier.

Generation of the predictive survey participation patterns may include some intermediate steps including identifying categories of collected behavioral data, grouping the behavioral data into categories based on the series of steps and/or events which occurred during the website visit, etc. The generation of the predictive survey participation patterns may further include another intermediate step of generating raw survey metrics for each behavioral category. In the context of the present disclosure, a behavioral category is a behavioral model that is associated with a metric, for instance a purpose of visit being Purchase. In general a plurality of behavioral categories are associated with a metric, and a similar or close behavioral category may be associated with distinct results for the same question of a survey. Accordingly, at the end of this step, for each desired metric for the survey, a series of behavioral categories with an associated result is generated and stored in memory, hereinafter referred as the predictive survey participation patterns.

At step 808, the survey server 40 compares the behavioral data for which no survey participation data has been collected, with behavioral categories, so as to determine a correlation indicator between the behavioral data for which no survey participation data was collected and the predictive survey participation patterns. This correlation permits to identify the most suitable predictive survey participation pattern to be related to the behavioral data for which no survey participation data has been collected, to generate a predicted survey participation data therefor. When the most suitable predictive survey participation pattern has been identified, based on the correlation indicator, the predictive survey participation pattern is applied to the behavioral data for which no survey participation data has been collected, so as to produce the predicted survey participation.

At step 810, the survey participation data and related behavioral data are compared and/or combined to the predicted survey participation data and related behavioral data. The comparison and/or combination result in the generation of the adjusted metrics in step 814. Resulting from this process, one or more adjusted metrics is associated to each visit or to groups of visits (with proportions when more than one adjusted metrics is associated). For instance, website visit(s) would be associated a proportion of 0.2 for Search and 0.8 for Purchase for a purpose of visit question, based on the correlation of behavioral data being of 0.2 and 0.8 for two categories, or a combinations of multiple categories summing up for each adjusted metrics to 0.2 and 0.8.

The adjusted metrics correspond to an extrapolation of the survey responses that user of user devices who did not participate in the survey may have provided, based on the responses provided by the portion of the visitors who participated in the survey, using the predictive survey participation patterns to perform the extrapolation.

The survey server may further provide a representative visual representation of the multiple metrics: a) factual metrics based solely on data provided by survey participants, and b) adjusted metrics including both factual results and predicted results.

The behavioral data corresponding to the visit of a particular website may be collected from different sources, including the user devices 20 visiting the particular website, a web server hosting the particular website, and a third-party server (the third party server collecting the behavioral data in relation with visits of the website).

Reference is now made to FIG. 11a and FIG. 11b. FIG. 11a and FIG. 11b illustrate schematic representations of factual metrics and adjusted metrics for a survey question related to the purpose of visit. FIG. 11a provides factual metrics representative of the proportion of the survey participants who responded to the survey according to one of the following category: Research (category A), Purchase (category B), and Other (category C). FIG. 11b provides adjusted metrics, based on the predictive survey participation patterns, which show that a higher portion of the visitors who did to participate in the survey or refused to participate are likely to have another response to the question about the purpose of visit. For comparison purpose, FIG. 11b also features the metrics represented on FIG. 11a using a dashed representation, while the adjusted metrics are illustrated through solid lines. Similar correction, not illustrated here, may be applied to ratings, selection of alternative, ordering of elements, and categories of meaning of free-form texts.

The exemplary graphical representation of the factual metrics and adjusted metrics provided in FIGS. 11a and 11b is for illustration purposes only, multiple alternatives known in the art to provide graphical representations of factual metrics and adjusted metrics may also be used.

In addition to generating predictive survey participation patterns, the present methods and servers may generate predictive contextual patterns. Similarly to the predictive survey participation patterns, the predictive contextual patterns are generated based on collected contextual data and related behavioural data. Thereafter, the collected contextual data and related behavioural data are grouped, so as to generate predictive contextual patterns. The predictive contextual patterns are applied to behavioural data for which no related contextual data has been received, so as to generate predicted contextual data.

The contextual data may include data used to customize the website visit experience. Some users of user devices may use particular website configurations or preferences (for instance preferences in relation with the presentation of the website). The web server 30 hosting the website generally stores the user device configurations and preferences in association with the session identifier or a visitor identifier. A visitor identifier is maintained over multiple website visits through the use of a cookie stored in memory of the user device 20. When the user device 20 of the returning user communicates again with the web server 30 for a new visit of the website, the cookie is transmitted from the user device 20 to the web server 30, and thereby the web server 30 identifies the visitor, retrieves from a preference database the configurations and preferences previously set by the user. The web server 30 applies the configurations and preferences to the webpage content transmitted to the visitor. Accordingly, through that process, a visit experience customized to the user according to earlier set data is generated. However, contextual data are not available for all the user devices, but they can be predicted using predictive contextual patterns, as illustrated in the following.

The survey server 40 collects a combination of survey participation data and contextual data from a plurality of user devices 20 visiting a website. The survey server 40 also collects only behavioral data from user devices 20 from which contextual data are not available. The survey server 40 analyzes the collected behavioral data and the related collected contextual data to generate predictive contextual patterns.

The survey server 40 further generates predicted contextual data for the user devices 20 for which no contextual data was collected, based on the behavioral data and the predictive contextual patterns. The predicted contextual data may consist of website configurations or preferences, which can be applied to the user devices 20 to improve the website visit experience.

The step of generating predictive contextual patterns by the survey server 40 may also comprise evaluating a correlation indicator between the behavioral data for which no contextual data was collected and the predictive contextual patterns.

The generation of the predictive contextual patterns may be performed by the survey server 40 on a scheduled manner or may be performed in real-time.

The survey server 40 provides a cookie readable and operable during a following session, or later during the same session. The cookie is stored with an identification of the domain of the website. Therefore, only the web server 30 or a third party such as the survey server 40 having been granted access to the webpage generated and displayed on the user device 20 by the web server 30 have the rights to read, write, and modify the cookie. During of after the website visit, the survey server 40 collects behavioral data from the user of the user device, analyzes the behavioral data to previously collected behavioral data from user devices with known contextual data (configurations and preferences), so as to determine predicted contextual data to be applied for the current website visit or in the context of the current website visit.

The predictive contextual patterns may be divided into categories, each category being associated with a general set of configurations and preferences having the higher odds to please the website visitors.

The predicted contextual data may be transmitted to the web server 30 in association with the visitor identifier. The predicted contextual data is either communicated upon generation by the survey server 40 to the web server 30 for allowing close to real time application of the preferences, for instance following a request from the user device 20 to access a new webpage, wherein new means not viewed during the current website visit.

Alternatively, the predicted contextual data may be communicated during predetermined communication exchanges, which take place at predetermined moments or fixed intervals between the survey server 40 and the web server 30. For example, a database at the web server 30 may be updated, following receipt of the predicted contextual data by the survey server 40. The database may include visitor identifier and/or user device identifier and/or session identifier, configurations and preferences data, and an indication regarding the configurations and preferences data being factual or predicted. Accordingly, the user of the user device 20 experiences the predicted configurations and preferences, which are applied at a following visit of the website after the update of the database.

The predicted contextual data may also be stored in the cookie located in the memory of the user device 20. Accordingly, when the survey server 40 determines the predicted contextual data for a visitor identifier and/or a user device identifier and/or a session identifier, the survey server 40 may transmit the predicted contextual data to the corresponding user device so as to update the cookie corresponding to the website. The cookie stored in memory of the user device 20 with respect to the domain of the website is modified to include predicted contextual data. The result is that, following that modification of the cookie, whenever the user device and the web server 30 communicate with one another, the predicted contextual data is applied to the user device and at the web server for the user device.

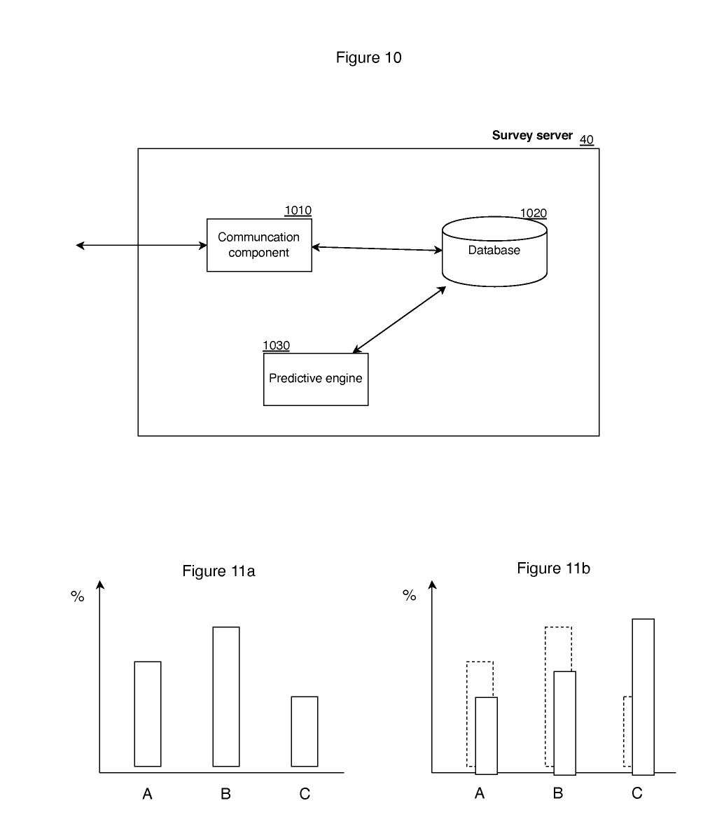

Referring now to FIG. 10, the survey server 40 is represented, comprising a database 1020 wherein a) visitor identifiers, b) behavioral data, and c) survey participation data are stored. Contextual data and predictive patterns are also stored in the database 1020. The survey server 40 further comprises a communication component 1010 receiving data from a plurality of user devices 20 during website visits. The survey server 40 is adapted to receive and process data from website visits overlapping between each other, and also from website visits of different domains. The survey server 40 also comprises predictive engine 1030 for predicting contextual data to be applied based on collected behavioral data.

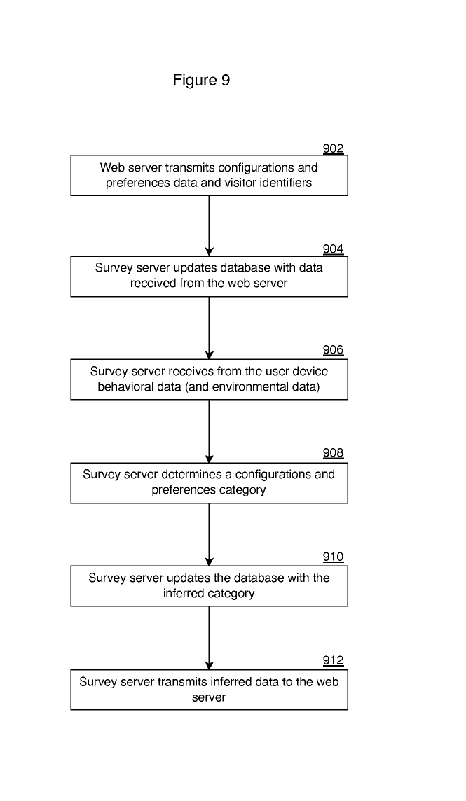

Reference is now made concurrently to FIGS. 9 and 10. FIG. 9 illustrates a flow chart for predicting contextual data based on collected behavioral data. The steps involved in the present alternative wherein the survey server 40 predicts contextual data and transmits the predicted conceptual data to the web server 30. Prediction of the contextual data is initiated by a script embedded in one or more webpages of the website or in the form of a cookie.

At step 902, the web server 30 transmits to the survey server 40 collected contextual data. Depending on the volume of collected data, the web server 30 may transmit the complete content of the database or simply new and updated data since the last data transmission. The collected contextual data may include configuration(s) and preference(s) data with a visitor identifier and/or a user device identifier and/or a session identifier.

At step 904, the survey server 40 receives from the web server 30 the collected contextual data updates the database 1020, wherein the data stored may include: a) visitor identifier and/or a user device identifier and/or a session identifier, b) configuration(s) and preference(s), c) timestamp of contextual data receipt, d) predictive contextual pattern, e) timestamp of predicted contextual data, and f) related behavioral data collected from the user device with any associated relevant data. Accordingly, the collected contextual data received from the web server 30 is placed in the database 1020 to be associated with the related collected behavioral data through association of the visitor identifier and/or a user device identifier and/or a session identifier.

At step 906, the survey server 40 collects from a user device 20 behavioral data as the user device 20 accesses webpages of the website and interacts with the displayed webpages. The received behavioral data also include an event identifying the end of the website visit by the user device 20. In some occasions, the collected behavioral data received from the user device 20 also include an indication of when the user has performed a setup of contextual data.

At step 908, according to a predetermined schedule, the survey server 40, through the predictive engine 1030, processes the collected behavioral data and related collected contextual data to generate the predictive contextual patterns. The predictive contextual patterns may be generated by groups, or in any other suitable fashion. Then, the predictive engine 1030 assigns to the user devices for which only behavioral data has been collected, a predicted contextual data based at least on the collected behavioral data of the user device. The survey server further updates the database 1020 with the predicted contextual data for the user device. The assignment of the predicted contextual data may further take into consideration determining at least one correlation indicator between the indicators in the behavior of the user of the user device with behavior of users with particular contextual data. The at least one correlation indicator used comprises any of the following, in any combination and/or order: a) indication that the website visit is a first visit, sequence of the webpages (URLs) visited, b) duration of the visit on each of the webpages, c) indication of use or not of some controls present on the webpages, such as a wish list control or a cart, d) lapse of time since the last visit of the website by the user of the user device, e) indication that the user of the user device has opened more than one webpage of the website in a concurrent manner during the session, and f) webpage scrolling behavior. By comparing these correlation indicators to the collected behavioral data, the predictive engine 1030 may generate a score (example a value between 1 and 64) for each of the correlation indicator. The score determination process for each of the correlation indicator may be performed before or concurrently to predicting the contextual data. The prediction of the contextual data for each visitor identifier and/or a user device identifier and/or a session identifier may thus be performed based on a) the predictive contextual data pattern featuring the best score among the determined scores, and b) the level of significance of the best score.

At step 910, the survey server 40 updates the database 1020 with the predicted contextual data and the timestamp of the predicted contextual data.

At step 912, the survey server 40 transmits the visitor identifier and/or a user device identifier and/or a session identifier along with the corresponding predicted contextual data to the web server 30. Accordingly, the web server 30 is able to update its database and provide a user of a user device with a customized webpage the next time the user of the user device visits the website.

The present disclosure has been described in a structural format and in a functional manner. In particular, it has been described as: a) a method performed on a processing system-based device such as the present processing system-based survey server, b) a processing system-based device, such as a server (e.g. the present processing system-based survey server). It may also have been described as: c) a computer program product comprising readable memory (such as a CD-ROM, an EEPROM or any other physical device capable of storing computer executable instructions) for storing computer executable instructions thereon, that when executed by a processing system-based device perform steps of the aforementioned method.

Although the present disclosure has been described in the foregoing description by way of the provided illustrative embodiments, these embodiments are not intended to limit the scope of the present disclosure. Other embodiments could have been provided that would also have been within the limitations of the present disclosure, since also within the scope defined by the appended claims. Therefore, the provided illustrative embodiments may be modified at will within the scope of the appended claims without departing from the spirit and nature of the present disclosure.

1. A method of generating predictive patterns for website analysis, the method comprising:
collecting at a survey server behavioral data from a plurality of user devices, the behavioral data being representative of a series of actions performed by a user of each of the plurality of user devices while visiting a website;
collecting at the survey server survey participation data from some of the plurality of user devices, the survey participation data corresponding to survey information received from the users of each of the plurality of the user devices in relation to the visiting of the website; and
analyzing by the survey server the survey participation data and related behavioral data to generate predictive survey participation patterns.

2. The method of claim 1, further comprising:
generating at the survey server website survey adjusted metrics based on:
the collected survey participation data; and
the predictive survey participation patterns for the behavioral data for which no survey participation data was collected.

3. The method of claim 1, further comprising evaluating a correlation indicator between:
the behavioral data for which no survey participation data was collected, and
the predictive survey participation patterns.

4. The method of claim 1, wherein the survey participation data is indicative of at least one of:
a rating, a selection of an element among a plurality of options, an ordering of elements among a plurality of elements, and a free-form text.

5. The method of claim 1, wherein collecting behavioral data comprises at least one of:
collecting the behavioral data from the user devices;
collecting the behavioral data from a web server hosting the website; and
collecting the behavioral data from a third-party server, the third party server collecting the behavioral data in relation with visits of the website.

6. The method of claim 1, further comprising:
collecting at the survey server contextual data related to at least some of the plurality of user devices visiting the website; and
wherein the analyzing by the survey server of the survey participation data and the related behavioral data further comprises analyzing the related collected contextual data.

7. A survey server comprising:
a processing system;
a communications interface for exchanging data with user devices; and
memory for storing:
related survey participation data and behavioral data for at least some of the user devices;
behavioral data for the other user devices; and
code responsible, when performed by the processing system for:
analyzing the related survey participation data and behavioral data for generating predictive survey participation patterns; and
generating survey adjusted metrics based on the stored survey participation data, and on the predictive survey participation patterns for the stored behavioral data for the other user devices.

8. The survey server of claim 7, wherein the code is further responsible for evaluating a correlation indicator between:
the behavioral data for the other user devices, and
the predictive survey participation patterns.

9. The survey server of claim 7, wherein the code is further responsible for at least one of:
collecting the behavioral data from the user devices;
collecting the behavioral data from a web server hosting the website; and
collecting the behavioral data from a third-party server storing the behavioral data.

10. A method of generating predictive contextual patterns comprising:
collecting at a survey server behavioral data from a plurality of user devices, the behavioral data being representative of a series of actions performed by a user of each of the plurality of user devices while visiting a website;
collecting at the survey server contextual data from some of the plurality of user devices, the contextual data corresponding to at least one of the following: hardware configuration, software configuration, user device configuration and user preferences; and
analyzing by the survey server the collected behavioral data and the related collected contextual data for generating predictive contextual patterns.

11. The method of claim 10, further comprising:
generating predicted contextual data for the user devices for which no contextual data was collected based on the behavioral data and the predictive contextual patterns.

12. The method of claim 10, wherein the step of generating predictive contextual patterns further comprises evaluating a correlation indicator between:
the behavioral data for which no contextual data was collected, and
the predictive contextual patterns.

13. The method of claim 10, wherein collecting behavioral data comprises at least one of:
collecting the behavioral data from user devices;
collecting the behavioral data from a web server hosting the website; and
collecting the behavioral data from a third-party server collecting the behavioral data in relation with visits of the website.

14. The method of claim 10, wherein collecting contextual data comprises:
collecting contextual data from a web server hosting the website.

15. The method of claim 10, wherein generating predictive contextual patterns is performed on a scheduled manner, or performed in real-time.

16. The method of claim 10, further transmitting the predictive contextual patterns in any of the following manner:
transmitting the predictive contextual patterns to a web server hosting the website, or
transmitting the predictive contextual patterns to a user device, wherein the user device is the one to which pertains the behavioral data used to generate the predictive contextual patterns.

17. A server comprising:
a processing system;
a communications interface for exchanging data with user devices; and
memory for storing:
related contextual data and behavioral data for at least some of the user devices;
behavioral data for the other user devices; and
code responsible, when performed by the processing system for:
analyzing the related contextual data and behavioral data for generating predictive contextual patterns; and
generating predicted contextual data for the other user devices based on the behavioral data and the predictive contextual patterns.

18. The server of claim 17, wherein the code is further responsible, when performed by the processing system for evaluating a correlation indicator between:
the behavioral data of the other user devices, and
the predictive contextual patterns.

19. The server of claim 17, wherein the code is further responsible for at least one of:
collecting the behavioral data from the user devices;
collecting the behavioral data from a web server hosting the website; and
collecting the behavioral data from a third-party server storing the behavioral data.
